(19) United States
(12) Patent Application Publication
(10) Pub. No.: US 2010/0104695 A1
(43) Pub. Date: Apr. 29, 2010

(54) INSTANT BEVERAGE CUBES

(76) Inventors: Nancy Z. Faella, Johnston, RI (US); Walter de J. Zapata, Itagui-Antioquia (CO)

Correspondence Address: BARLOW, JOSEPHS & HOLMES, LTD., 101 DYER STREET, 5TH FLOOR, PROVIDENCE, RI, 02903, US

(21) Appl. No.: 12/258,658

(22) Filed: Oct. 27, 2008

(51) Int. Cl. A23L 1/302; A23P 1/02; A23F 5/00; A23F 3/00; A23G 1/50

(52) U.S. Cl. 426/72; 426/285; 426/594; 426/597; 426/593

(57) ABSTRACT

A solid cube is provided that is dissolved in water or milk to produce a beverage. The solid cube is formed using pulverized Panela (of common use in Colombia) freeze-dried beverage materials such as coffee and artificial flavors as basic ingredients. The solid cube is prepared by mixing the ingredients in a dry atmosphere and shaping them to the desired size and shape using a non-stick mold and compression molding techniques.

### BACKGROUND OF THE INVENTION

The present invention relates generally to a dry packaged, water-soluble beverage material. More specifically, the present invention relates to a dry packaged instant beverage material that is formed into a tablet that is later dissolved in water or milk for consumption.

In the prior art there are a number of different process for producing beverages such as instant coffee or instant tea. In addition there are other dry packaged substances that a consumer can dissolve in water to create a desired beverage. Generally, these processes are directed to the formation of granular agglomerate or tablets consisting of the various dry ingredients employed in the beverage substance. In the case of agglomerates, dry ingredients such as instant coffee, sugar and powdered milk are blended and combined. The material is then ground to a fine particle size, moistened, agitated and dried to form the granular agglomerate. In the case of tablets or cubes, which are usually sized so that they are sufficient to make one cup of the beverage, the tablets are formed by combining the various ingredients used in the beverage with a binder material such as fat or an emulsifier. This material is then formed into the desired shape. Alternately, a beverage cube can be made by combining the flavor material with a carrier vehicle (such as ethyl alcohol) and water to form a damp, but non-cohesive powder. The damp powder is the formed into a cube under pressure and dried to evaporate the carrier vehicle.

The problem is that the agglomerates formed by previous methods are generally unsatisfactory because it is difficult to measure out the proper amount when the beverage is made and the material is difficult and inconvenient to store. Additionally, powdered beverage materials will absorb moisture on repeated exposure of the opened jar and thereby, lose valuable flavor and aroma. The cubes or tablets formed by prior methods also have disadvantages in that the binder or vehicle is never completely eliminated from the beverage and may affect its taste and appearance. Further, when fat or an emulsifier is used as the binder, it must disperse the material is not visible on the surface of the beverage. Finally, beverage cubes such as coffee are conventionally prepared from soluble coffee extractives. This method involves subjecting ground coffee beans to the action of an extracting solvent and evaporating the concentrate abstract to the condition of agglomerate, which is then compressible into tablet form. However, coffee tablets formed by these prior procedures have disadvantages in that the flavor of the pure coffee extractives is always lost in the course of formulation since the extrinsic binder or vehicle is never completely removed from the beverage which affects its taste and appearance.

There is therefore a need for a dry packaged, water-soluble beverage material that is dry formed and does not require a use of a binder that will alter the taste and appearance of the finished beverage. Further, there is a need for a dry packaged instant beverage material that is formed into a tablet without the use of an added binder or carrier vehicle that is later dissolved in water or milk for consumption.

### BRIEF SUMMARY OF THE INVENTION

In this regard, the present invention is directed to a method and a composition for use in making instant beverages. More specifically, the present invention is directed to a dry packaged, water-soluble beverage material that is dry formed into a tablet without using a binder. Since conventional binders or vehicles are not used, the resulting product has an improved taste and appearance as compared to the beverages of the prior art.

In accordance with the present invention a solid cube is provided that is dissolved in water or milk to produce a beverage. In the most general terms, the solid cube is formed using pulverized Panela (of common use in Colombia) freeze-dried beverage materials such as coffee and artificial flavors as basic ingredients. The appearance and flavor of the final product is of a high quality wherein the flavor and texture of the original beverage material is preserved as the material remains in as unadulterated state as possible. Further, because of the simplicity of the materials employed in the formation of the beverage cube of the present invention manufacturing time and costs are greatly reduced.

The solid cube is produced without the use of agglutinant to consolidate the cube and retain its form. Further, refined sugar, which has the tendency to attract moisture and make the manufacturing process more difficult, is not employed in the formation of the cubes allowing the cubes to be more solid and less likely to degrade from the absorption of moisture. Finally, the conventional procedures of submitting the materials to high temperatures in closed chambers is avoided thereby preserving aroma and flavor of the beverage flavoring material in its original state.

Accordingly, it is an object of the present invention to provide a dry packaged, water-soluble beverage material that is dry formed and does not require a use of a binder that will alter the taste and appearance of the finished beverage. It is a further object of the present invention to provide a dry packaged instant beverage material that is formed into a tablet without the use of an added binder or carrier vehicle that is later dissolved in water or milk for consumption.

These together with other objects of the invention, along with various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a schematic diagram illustrating the process of the present invention.

### DETAILED DESCRIPTION OF THE INVENTION

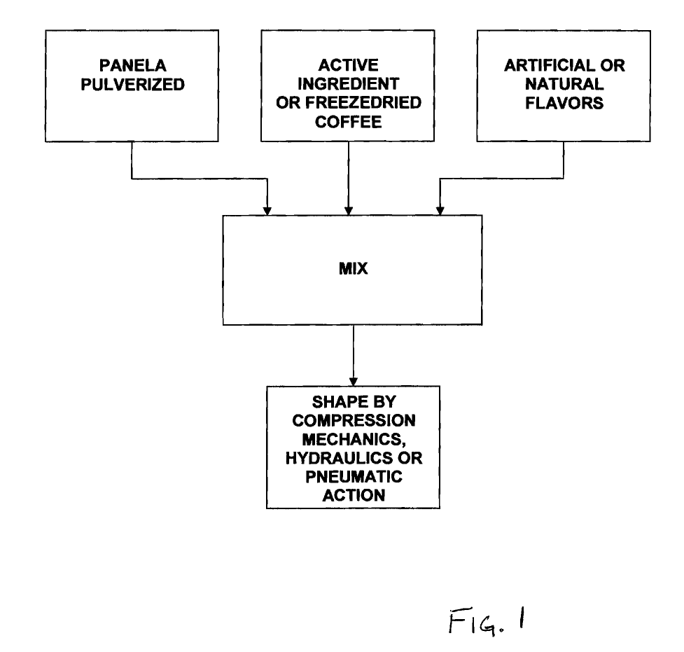

Now referring to the drawings, FIG. 1 schematically illustrates a process for making beverage cubes or tablets containing an active ingredient that are sweetened and flavored, and which readily dissolve in water. The tablets are easy to handle and are formulated so that one or two of the tablets will deliver the desired concentration of the active ingredient when dissolved in an appropriate amount of water or milk.

Generally, the process for manufacturing the cubes involves mixing ground particles of Panela with ground particles of an active ingredient and optionally an additional flavor additive. These materials are then blended forming a mixture that is then placed into a mold. The mixture within the mold is subjected to compression molding and is then removed from the mold ready fro packaging and shipment to the consumer.

It is of note that one of the principal ingredients employed in the present invention is Panela. Panela is an unrefined extract of raw sugar cane. In extracting Panela from the sugar cane a crusher is used to extract the juice. This extracted juice is then boiled and clarified. The juice is then strained and boiled again until it approaches the point of crystallization. If the juice is taken out too soon, it will not crystallize; if too late, it will have scorched. At just the right point, the nearly dry but coarse crystals of are molded into Panela loaves. It is this Panela material that serves as the bas material in the composition of the present invention. The use of Panela is important because in contrast to sugar or other prior art materials wherein a binder is used, the Panela itself serves both as a sweetener and a binder. Further, since the Panela is low in moisture content and highly crystallized it is not sticky and does not absorb large quantities of atmospheric moisture.

Further the composition contains an active ingredient that may be selected from the group consisting of: beverage materials, nutritional supplements and vitamins. More preferably, the active ingredient is a beverage material selected from the group consisting of: coffee, tea and cocoa. Still more preferably, the active ingredient is freeze-dried coffee. It is important to note however that the process and composition of the present invention is equally suitable for the formation of convenient to dispense tablets that could contain nutritional supplements such as vitamins or minerals as easily as containing a beverage material. Still further, the composition may also include additional flavoring additives as will be described in more detail below.

In forming the tablets of the present invention, the pulverized Panela becomes the agglutinant, so when the composition is placed into the mold it is the Panela that is compacted by mechanical, hydraulic or pneumatic action causing the tablet to bind in a solid state. Allowing the tablets to be handled immediately upon removal from the mold. This forms a tablet that is practical, easy to prepare and to use and which is designed to the concentration of the beverage desired and for the quantity desired to drink. In this case, the tablets are designed for use of one tablet per 3 to 4 oz. of water or milk, although other concentrations and tablet sizes would still fall within the scope of the present invention. Accordingly, the tablets made in accordance with the present invention are easily dissolved hot or cold milk, water or even yogurt to form a beverage or dessert item while also being strong and resistant to breakage.

Preferably the tablet is formed of approximately 80% to 93% by weight of Panela and about 7% to 20% by weight of an active ingredient is mixed. Additionally, if a flavoring is to be used the mixture may be approximately 80% to 93% by weight of Panela, about 5% to 15% by weight of an active ingredient and about 1% to 2% by weight flavoring. After combining all of the above ingredients, the mixture is poured into special non-stick molds to avoid adhering to the walls of the mold. Once the mixture is in the molds, it is compressed by mechanical, hydraulics, or pneumatic action to give it form and cause it to solidify. In this manner, the present invention avoids the use of high temperatures and accordingly does not affect the quality or flavor o the ingredients. Further, this process eliminates the need for a cutting process and a cooling time thereby optimizing the use of manufacturing time and space. Further, this process eliminates the need for special chambers with high levels of humidity as was the case with prior art sugar binders. As in the present invention, the working environment should be humidity free in order to prevent the mixture from becoming a sticky mess and therefore very difficult to manipulate and handle.

Flavorings employed in the present invention may include cappuccino, amaretto, baileys, vodka, whisky, pistachio, mocha, hazelnut, hazelnut cream, almond, mint, vanilla, sweetened condensed milk, cinnamon, thyme, lemon, orange, passion fruit, blackberry, banana, pineapple, kiwi, grape, peach, strawberry, cherry, mandarin, guava, pear, apple, papaya, mango, tamarind, cardamom, chamomile, lemon grass, sweet marjoram and cidron. Further, the flavorings may be in the form of a powder or an extract. By tailoring the composition of the flavorings the beverages may be suitable as desert items.

### EXAMPLE

We have achieved good results with mixtures that vary between 80% to 93% of Panela; 6% to 19% of freeze-dried coffee; and 1% to 2% of artificial flavor. In one example a mixture was prepared using 87% Panela, 11% freeze-dried coffee, and 2% artificial flavor. The particles of the coffee and artificial flavor are ground to a particle size of approximately 20 mesh and the pulverized Panela has a particle size distribution of between 30 and 100 mesh. The mixture was poured into the non-stick molds and compressed.

It can therefore be seen that the present invention provides a dry packaged, water-soluble beverage material that is dry formed and does not require a use of a binder that will alter the taste and appearance of the finished beverage. Further the present invention provides a dry packaged instant beverage material that is formed into a tablet without the use of an added binder or carrier vehicle that is later dissolved in water or milk for consumption. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A method of manufacturing a solid water-soluble tablet comprising:
forming a mixture of approximately 80% to 93% by weight of Panela and about 7% to 20% by weight of an active ingredient;
placing said mixture into a non-stick mold; and
compressing said mixture to form a solid tablet.

2. The method of claim 1, wherein said active ingredient is selected from the group consisting of beverage materials, nutritional supplements and vitamins.

3. The method of claim 1, wherein said active ingredient is a beverage material selected from the group consisting of: coffee, tea and cocoa.

4. The method of claim 1, wherein said active ingredient is freeze-dried coffee.

5. The method of claim 4, wherein said mixture is approximately 87% by weight of Panela and about 13% by weight freeze-dried coffee.

6. The method of claim 1, wherein said mixture is compressed in said mold using mechanical, hydraulic or pneumatic action.

7. A method of manufacturing a solid water-soluble tablet comprising:
forming a mixture of approximately 80% to 93% by weight of Panela, about 5% to 15% by weight of an active ingredient and about 1% to 2% by weight flavoring;
placing said mixture into a non-stick mold; and
compressing said mixture to form a solid tablet.

8. The method of claim 7, wherein said active ingredient is a beverage material.

9. The method of claim 8, wherein the beverage material is selected from the group consisting of: coffee, tea and cocoa.

10. The method of claim 7, wherein said active ingredient is freeze-dried coffee.

11. The method of claim 7, wherein said active ingredient is freeze-dried coffee.

12. The method of claim 11, wherein said mixture is approximately 87% by weight of Panela, about 11% by weight freeze-dried coffee and about 2% by weight flavoring.

13. The method of claim 7, wherein said mixture is compressed in said mold using mechanical, hydraulic or pneumatic action.

14. A solid water-soluble tablet comprising:
approximately 80% to 93% by weight of Panela; and
about 7% to 20% by weight of an active ingredient.

15. The tablet of claim 14, wherein said active ingredient is selected from the group consisting of beverage materials, nutritional supplements and vitamins.

16. The tablet of claim 14, wherein said active ingredient is a beverage material selected from the group consisting of: coffee, tea and cocoa.

17. The tablet of claim 14, wherein said active ingredient is freeze-dried coffee.

18. The tablet of claim 14, comprising approximately 87% by weight of Panela and about 13% by weight freeze-dried coffee.

19. The tablet of claim 14, comprising approximately 80% to 93% by weight of Panela, about 5% to 15% by weight of an active ingredient and about 1% to 2% by weight flavoring.
